(19) United States
(12) Patent Application Publication
(10) Pub. No.: US 2010/0110000 A1
(43) Pub. Date: May 6, 2010

(54) VISUAL DISPLAY SYSTEM AND METHOD FOR DISPLAYING A VIDEO SIGNAL

(75) Inventor: Petrus M. De Greef, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/525,137

(22) PCT Filed: Feb. 8, 2008
(86) PCT No.: PCT/IB2008/050466

§ 371 Date: Jul. 30, 2009

(30) Foreign Application Priority Data
Feb. 13, 2007 (EP) 07102243.8

(51) Int. Cl. H05B 37/02; G09G 5/00

(52) U.S. Cl. 345/156; 315/294; 315/152

(57) ABSTRACT

A video display system (100) is provided which comprises a display panel (DP) for displaying a video signal (V), at least one lighting unit (LU) for providing a surround or ambient lighting (LS), a user interface (UI) for receiving external user calibration signals and a lighting control unit (LC) for controlling the color and/or luminance of the lighting unit (LU) in dependence on the calibration signals received by the user interface (UI).

### FIELD OF THE INVENTION

The present invention relates to a visual display system and method for displaying a video signal.

### BACKGROUND OF THE INVENTION

Apparatuses for presenting images to viewers are well known and include televisions and computer monitors. Televisions are contemporarily implemented using cathode ray tubes, liquid crystal displays employing pixel arrays, plasma displays, light emitting diode (LED) displays to mention a few contemporary examples. For televisions, there is a growing desire for relatively broad screens to accommodate high-definition television (HDTV) program content. However, relatively large displays for televisions are costly to manufacture and tend also to be bulky, especially when implemented using cathode ray tube technologies. It has been appreciated that it is not necessary to increase both screen resolution and display size in order to provide viewers with an enhanced viewing experience because viewers are less able to distinguish fine detail at a perimeter of their field of vision in comparison to a central region thereof. Thus, an enhanced visual experience for viewers can be provided by employing surround-lighting wherein a surrounding halo of illumination dynamically complementary to images presented on a monitor is provided around the monitor.

Such surround-lighting can be provided by way of light-sources 10 arranged around a monitor 20 as schematically illustrated in FIG. 2, or by backward illumination 30 for illuminating a region 40 behind the monitor 20 relative to a viewer 50. The backward illumination is optionally directed to provide a halo of illumination around the monitor 20 when viewed by the viewer 50. While the use of the light-sources 10 arranged around the monitor 20 increases an overall physical size and hence bulk of an overall housing for the monitor 20, backward illumination can be implemented without increasing monitor size significantly. However, the use of the backward illumination for generating the surround-lighting, namely halo of illumination, requires a light-reflecting surface to be placed behind the monitor 20. The surface can be beneficially implemented as white reflecting panels attached to the monitor 20, for example rotatably-mounted fold-out panels or attachable panels, or more simply by mounting or positioning the monitor 20 in close proximity to an existing wall or similar existing surface. However, such existing surfaces can be of unpredictable color depending upon where the viewer chooses to place the monitor 20, such unpredictable color potentially affecting the color and quality of the surround-lighting achieved by this backward illumination 30. Moreover, environmental illumination around the monitor 20, such environmental illumination arising from room lighting and/or sunlight, can affect the quality of the surround-lighting as perceived by the viewer 50. A conventional solution is simply to require that the monitor 20 be mounted in proximity to a white surface or provide the monitor 20 with deployable white surfaces for reflecting the backward-illumination 30 towards the viewer 50.

WO 2005/062608 discloses a visual display system with a plurality of illumination sources partially surrounding an image display region. The illumination sources can be controlled according to the video signal to be displayed on the image display region.

WO 2006/003624 A1 discloses a method for extracting video content encoded in a rendered color space for broadcast by an ambient light source.

The above-described TV systems are typically placed in a living room or in a conference room. The system may have a LCD panel or a plasma panel for displaying a video signal. Ambient or surround light sources are used to project light with a color to the wall within e.g. a living room. The color being projected to the wall is supposed to represent an extension to those colors which are displayed on the display panel. It should be noted that walls do not necessarily have an optimal white color as walls of a living room are often painted. Moreover, those light sources which are used to project a color on the wall may only have a very narrow spectrum for example when LEDs are used such that the colors reflected from the wall may have a different color than CCFL lamps with the same color gamut such that artifacts may be enhanced. In addition to the light sources of the TV system, also other light sources present in the living room may contribute to the reflection of the wall behind the television system. Furthermore, the luminance as well as the color of ambient light lamps may drift over time. Moreover, the luminance and the color of the display panel or the backlight panel may also drift over time. Finally, the environment of a TV system with ambient light sources may be located in front of a wall which is not symmetrically decorated because of different decoration, angles/colors in the wall, height of the ceiling, etc.

### SUMMARY OF THE INVENTION

It is therefore an object of the invention to provide a visual display system which may take into account different conditions and environments of the visual display system.

This object is solved by a visual display system according to claim 1 and a method according to claim 5.

Therefore, a video display system is provided which comprises a display panel for displaying a video signal, at least one lighting unit for providing a surround or ambient lighting, a user interface for receiving external user calibration signals and a lighting control unit for controlling the color and/or luminance of the lighting unit in dependence on the calibration signals received by the user interface.

According to an aspect of the present invention, the video display system furthermore comprises a test patch generator for generating at least one test patch and for forwarding the test patch to the display panel such that the test patch is displayed on the display panel. The user interface is adapted to receive an external user calibration signal in response to the display of the at least one test patch.

The invention also relates to a method for displaying a video signal on a video display system. A video signal is displayed on a display panel. At least one lighting unit provides a surround or ambient lighting. External user calibration signals are received via a user interface. The color and/or luminance of the lighting unit is controlled by a lighting control unit in dependence on the calibration signal received by the user interface.

The invention relates to the idea to provide a video display system with a display unit and an ambient light source, wherein the luminance and the color of the ambient light source can be calibrated by a user. As the user can calibrate the ambient light sources according to the actual environment of the video display system, an optimal result of the provision and control of the ambient light sources can be achieved. The perception of the display unit and the ambient light sources of the video display system depend on the ambient conditions like opening/closing curtains, the position of walls and windows as well as the changing and reflection of the color of the ambient light sources and the reflection thereof on a wall.

According to an aspect of the invention, an interactive user feedback is used to calibrate color and luminance settings of ambient light background lighting to obtain an optimal perceived color reflection of light projected to a wall behind a TV system, wherein the color reflection visually matches the perceived colors of the display panel. The calibration of the color and luminance settings can be performed by means of a remote control, i.e. a TV user interface supporting a color and/or luminance control of the ambient light sources. By means of this calibration, the color and luminance of the ambient light sources can be adjusted to visually match perceived colors of a display panel.

### BRIEF DESCRIPTION OF THE DRAWINGS

Embodiments and advantages of the present invention will now be described with reference to the drawings.

FIG. 1 shows an illustration of an environment of a video display system according to a first embodiment, and

FIG. 2 shows an illustration of a video display system with a surround-lighting according to the prior art.

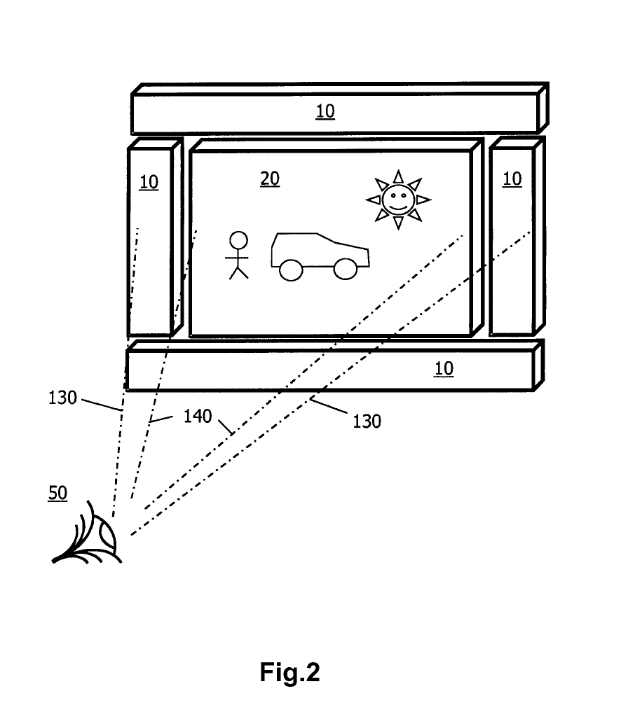

### DETAILED DESCRIPTION OF EMBODIMENTS

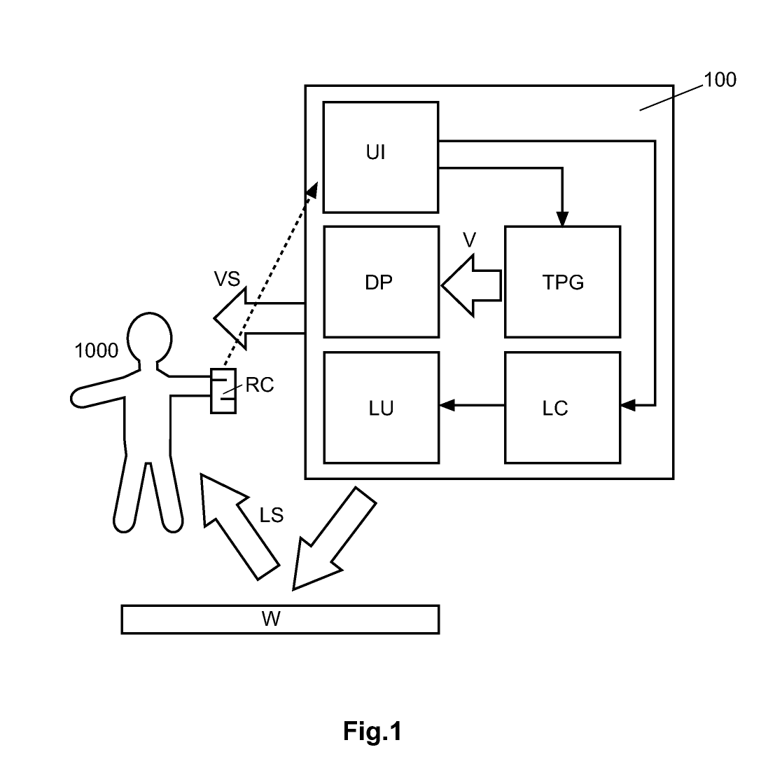

FIG. 1 shows an illustration of an environment of a video display system according to a first embodiment. The video display system 100 according to the first embodiment comprises a user interface UI, a display panel DP, a lighting unit LU, a test patch generator TPG and a light control unit LC. The display panel DP is used to display the video signal VS while the light unit LU is used to generate a surround or ambient lighting LS which is reflected by a wall W and perceived by a user 1000. A remote control RC may be provided to enable a (wireless) communication with the user interface of the display system. According to the commands inputted to the remote control RC and received by the user interface UI, the display panel DP as well as the light unit LU can be controlled or calibrated by the user 1000. The light control unit LC is used to control the color and luminance of the light units LU.

Accordingly, the user 1000 will perceive the video signal VS displayed on the display panel DP as well as the ambient or surround light LS reflected from a wall W. The color as well as the luminance of the reflected light LS reflected of the wall W may differ from the color and luminance of the light unit LU as several ambient conditions may influence the color and the luminance as well as the reflection on the wall W. The user 1000 will perceive the color and luminance displayed on the display panel DP as wells the color and luminance of the light LS reflected from the wall and can compare these two and can forward the results thereof by means of the remote control RC to the user interface UI in the video display system 100.

In order to facilitate a calibration of the color and luminance of the light units LU as compared to the color and luminance of the display panel DP, a test patch generator TPG can be provided in the video display system 100, which outputs a test patch V to the display panel DP such that the test patch is displayed. The light unit LU will accordingly display a corresponding surround lighting or ambient lighting. By means of the remote control RC and the user interface UI, the user 1000 can adjust the luminance and color of the light units LU according to the test patch which is displayed on the display panel DP. The test patch may have a uniform color like red, green, blue and white. Alternatively or in addition, the test patch may also have several colors and/or may comprise of a sequence of several test patches with different colors. The user can adjust the luminance and the color of the light unit LU via the remote control and the user interface such that they match with the color and luminance of a test patch being displayed on the display panel DP. The settings of the color and the luminance of the light unit LU as determined by the user can be stored in the visual display system such that they may be reused during the usual operation of the video display system. The user settings may then be used as normal operation settings such that a calibration of the color and the luminance of the light unit LU can be achieved.

According to the invention, even if the light LS reflected by a wall and generated by the light unit LU for supplying surround or ambient lighting has a undesired or wrong color or luminance due to the color or the geometry of the wall or due to any other conditions, the color and luminance of the light unit LU can be adjusted until the light LS reflected by the wall W has the right color and the right luminance. By generating test patches which are displayed on the display panel DP, a user may set a reference for tuning the color and luminance of the light unit LU. The user specific settings can be stored in the video display system such that they can be re-used during the normal operation of the video display system. The lighting units LU according to the first embodiment may comprise CCFL lamps or LED. By means of the above-described video display system, a user feedback loop (light unit LU, wall W, user 1000, remote control RC, user interface UI and light control unit LC) can be provided. Such a user feedback loop may enhance the control of the color and luminance of the light units LU.

In order to implement the above-described basic idea of the invention, the user interface UI needs to be modified. This can for example be performed by modifying the software of the user interface UI. Furthermore, the control of the light units LU needs to be modified such that the light units LU can be controlled by a light control unit LC.

The user interface can (optionally) only be activated during a calibration operation, i.e. when a test path is generated and displayed on the display panel. After the calibration process has ended, the settings for the lighting unit can be stored in a non-volatile memory within the video display system such that the settings can be reused. The calibration operation can be initiated for example by the user via the remote control and the user interface. Alternatively, the calibration process can be activated by the video display system at regular intervals.

According to the invention, an improved video display system can be provided with a little amount of extra hardware/software.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. A video display system, comprising:
a display panel for displaying a video signal,
at least one lighting unit for providing a surround or ambient lighting,
a user interface for receiving external user calibration signals, and
a lighting control unit for controlling a color and/or a luminance of the lighting unit in dependence on the calibration signals received by the user interface.

2. The video display system according to claim 1, further comprising:
a test patch generator for generating at least one test patch and for forwarding the test patch to the display panel such that the test patch is displayed on the display panel,
wherein the user interface is adapted to receive the external user calibration signal in response to the display of the at least one test patch.

3. The video display system according to claim 1, wherein during a calibration operation the user interface is activated for receiving external user calibration signals,
wherein during the calibration operation the test patch generator is initiated to generate at least one test patch and to forward the test patch to the display panel.

4. The video display system according to claim 1, wherein settings for the lighting unit based on the received external user calibration signals are stored in a non-volatile memory.

5. A method for displaying a video signal on a video display system, comprising the steps of:
displaying a video signal on a display panel,
providing a surround or ambient lighting by at least one lighting unit
receiving external user calibration signals by a user interface, and
controlling the color and/or the luminance of the lighting unit in dependence on the calibration signals received by the user interface.
